(19) United States
(12) Patent Application Publication
(10) Pub. No.: US 2009/0077878 A1
(43) Pub. Date: Mar. 26, 2009

(54) PLANT WIDGET

(76) Inventors: Jack F. Simpson, Clackamas, OR (US); Mary Jean Simpson, Clackamas, OR (US)

Correspondence Address: NW-IP-LAW, 6039 E. Grant RD., Tucson, AZ, 85712, US

(21) Appl. No.: 11/861,470

(22) Filed: Sep. 26, 2007

(51) Int. Cl. A01G 9/12

(52) U.S. Cl. 47/46

(57) ABSTRACT

The present invention features a plant widget comprising a holding plate, a first supporting member attached to the holding plate, and a second supporting member attached to the first supporting member. In some embodiments, the holding plate comprises at least one aperture. In some embodiments, the holding plate comprises a variety of sizes and shapes.

### FIELD OF THE INVENTION

The present invention is directed to a plant widget that includes a holding plate, a first supporting member, and a second supporting member to enable a person to easily transfer a plant of varying heights from a first pot to a second pot or a plot of ground after seeds have grown into a larger plant. The inventive design of the present plant widget facilitates repotting.

### BACKGROUND OF THE INVENTION

Persons planting seeds in potting soil in a first pot often wish to have a way to easily transfer a plant that grows from the seeds along with the potting soil into a second pot or a plot of ground. They also may wish to have a supporting member to enable the plant to grow to a variety of heights without bending over from the weight of the plant. However, most persons who wish to easily transfer a plant must dig around the potting soil and lift the potting soil from the first pot and transfer it by hand into the second pot or the ground. One problem of digging around the potting soil is that some soil may be cut by a tool and be left in the first pot. This makes the potting soil less stable and the plant less stable, sometimes causing it to bend. Additionally, the soil may crumble into smaller pieces and the plant may become detached from the potting soil.

Therefore, there is a need for an improved plant widget, where a person may easily plant seeds in potting soil in a first pot and transfer the plant into a second pot or a plot of ground, while still maintaining stability for the plant.

### SUMMARY OF THE INVENTION

The present invention features a plant widget comprising a holding plate, a first supporting member attached to the holding plate; and (optionally) a second supporting member attached to the first supporting member. In some embodiments, the holding plate comprises at least one aperture. In some embodiments, the holding plate comprises a variety of sizes and shapes.

One of the advantages of the present plant widget is that it can support a plant as the plant grows. The other advantage is that the plant widget makes it easy to perform transplanting.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

FIG. 1 is an illustration of a plant widget according to the invention including a holding plate, a first supporting member, and a second supporting member.

FIG. 2 is an illustration of a plant widget according to the invention including a holding plate, a first supporting member telescopically received by a second supporting member, wherein the plant widget is placed in a pot.

FIG. 3 is an illustration of a plant widget according to the invention as used including a holding plate, a first supporting member, a second supporting member, crushed rock, potting soil, and a plant.

FIG. 4 is an illustration of a plant widget according to the invention wherein the first supporting member is attached to the holding plate at a position away from the center of the holding plate.

### DESCRIPTION OF PREFERRED EMBODIMENTS

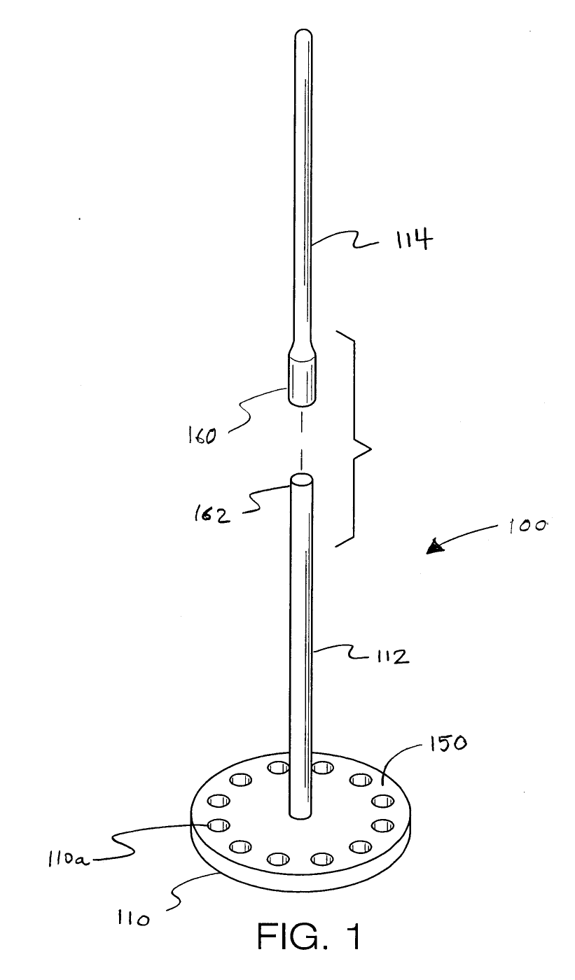

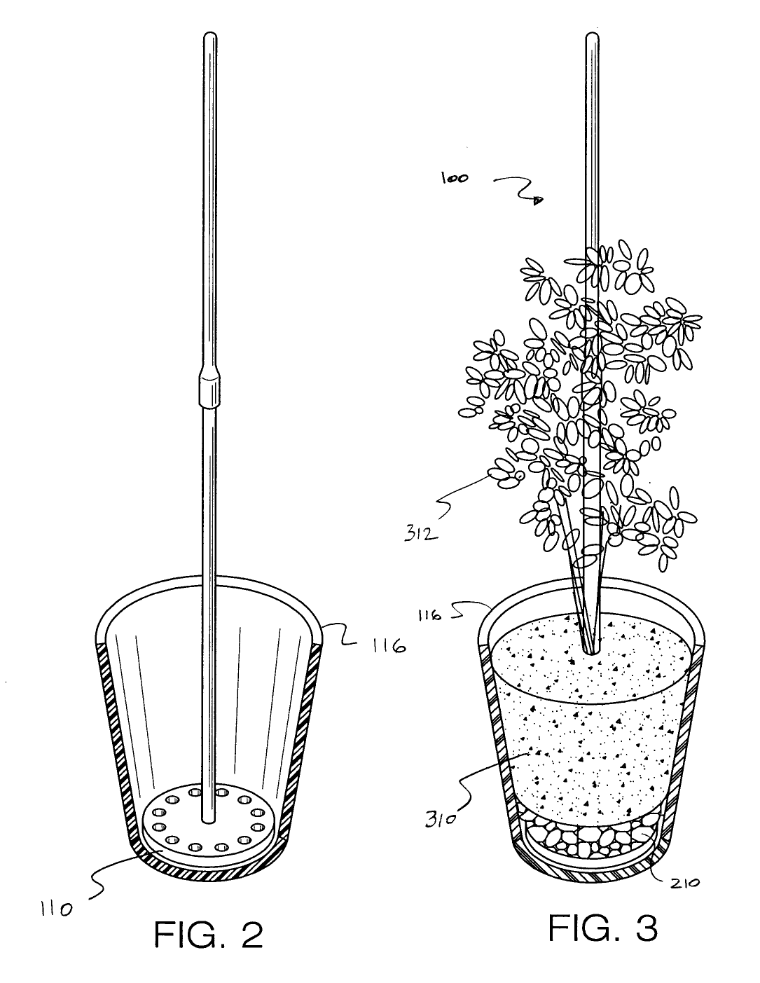

Referring now to FIG. 1 and FIG. 2, plant widget 100 comprises holding plate 110 having an upper surface 150 and a lower surface, a first supporting member 112 outwardly (e.g., vertically or orthogonally) attached to the upper surface 150 of the holding plate 110, and (optionally) a second supporting member 114 attached to the first supporting member 112, wherein the first supporting member 112 is received in the bottom end 160 of the second supporting member 114. In some embodiments, the bottom end 160 of the second supporting member 114 has an opening where a free end 162 of the first supporting member 112 can snugly insert.

The holding plate comprises an upper surface 150 and a lower surface (not visible). In the illustrated embodiment of FIG. 1, holding plate 110 comprises at least one aperture 110a with openings on the upper surface 150 and the lower surface, wherein the openings are fluidly connected by a channel (not shown). In some embodiments, the holding plate 110 comprises at least one hole (i.e., aperture) connecting the upper surface 150 and the lower surface. In the illustrated embodiment of FIG. 2, holding plate 110 fits tightly within the bottom of pot 116. In the illustrated embodiment of FIG. 2, pot 116 comprises a standard pot known to one skilled in the art. In the illustrated embodiment of FIG. 1, first supporting member 112 is telescopically received in the bottom end of second supporting member 114. The user may choose a variety of heights for first supporting member 112 and second supporting member 114 to fit the plants growth needs. In the illustrated embodiment of FIG. 1, first supporting member 112 is attached to holding plate 110 by conventional attachment means, such as welding, plastic welding, mechanical fasteners, and the like.

In certain embodiments, holding plate 110 comprises a rigid material selected from the group consisting of metal, clay, engineering plastic, or combinations thereof. In certain embodiments, holding plate 110 comprises a circular member having a diameter between about 4 inches and about 10 inches. In certain embodiments, holding plate 110 comprises a thickness between about ⅛ inch and about 1 inch. In certain embodiments, the holding plate comprises any geometric shape, e.g., a square member, a rectangular member, a triangular member, and the like. As used herein, the term “about” means plus or minus 10%.

In certain embodiments, first supporting member 112 comprises a rigid material selected from the group consisting of metal, engineering plastic, wood, or combinations thereof. In certain embodiments, first supporting member 112 comprises a tubular member having an outside diameter between about ¼ inch and about 1 inch. In certain embodiments, first supporting member 112 comprises a tubular member having a length between about 12 inches and about 36 inches. In other embodiments, first supporting member 112 comprises a solid member comprising a circular cross-section. In other embodiments, first supporting member 112 comprises a solid member comprising a triangular cross-section. In other embodiments, first supporting member 112 comprises a solid member comprising a square cross-section. In other embodiments, first supporting member 112 comprises a solid member comprising a rectangular cross-section.

In certain embodiments, second supporting member 114 comprises a rigid material selected from the group consisting of metal, engineering plastic, wood, or combinations thereof. In certain embodiments, second supporting member 114 comprises a tubular member having an outside diameter between about ¼ inch and about 1 inch. In certain embodiments, second supporting member 114 comprises a tubular member having a length between about 12 inches and about 36 inches. In other embodiments, second supporting member 114 comprises a solid member comprising a circular cross-section. In other embodiments, second supporting member 114 comprises a solid member comprising a triangular cross-section. In other embodiments, second supporting member 114 comprises a solid member comprising a square cross-section. In other embodiments, second supporting member 114 comprises a solid member comprising a rectangular cross-section.

Referring now to FIG. 3, plant widget 100 comprises holding plate 110, first supporting member 112, and second supporting member 114. When plant widget 100 is placed within pot 116, the user places crushed rock 210 on top of holding plate 110 for drainage purposes and extra weight to hold plant widget 100 in place within pot 116. The user then fills the pot 116 with planting soil 310 (see FIG. 3) and plants the seed/s within the potting soil 310.

Referring now to FIG. 3, plant widget 100 comprises holding plate 110, first supporting member 112, and second supporting member 114. After a user has planted seed within potting soil 310, a plant 312 will grow. As plant 312 grows, it will attach itself to first supporting member 112 and second supporting member 114 as it grows upwardly. In the illustrated embodiment of FIG. 3, the user may extend second supporting member 114 from first supporting member 112 as plant 312 grows taller.

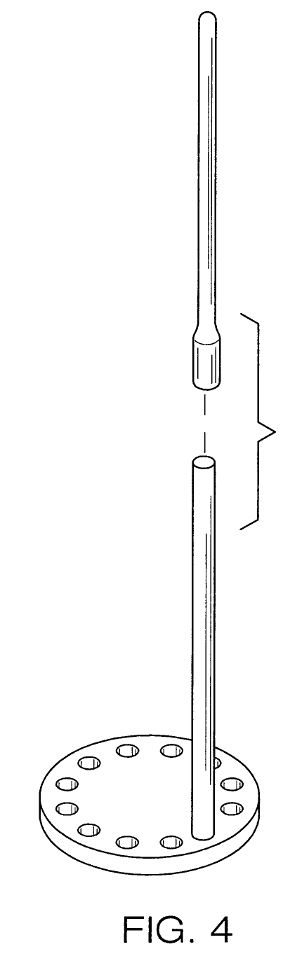

In some embodiments, plant widget 100 comprises holding plate 110, first supporting member 112, and second supporting member 114. After a user has planted seed within potting soil 310, a plant 312 will grow. When plant 312 gets to a desired length, the user may transfer plant 312 into a second pot or into a plot of ground. In the illustrated embodiment of FIG. 4, first supporting member 112 is attached to holding plate 110 off to one side (e.g., the first supporting member 112 is not at the center or is off center on the upper surface 150 of the holding plate 110). A user may lift first supporting member 112 and second supporting member 114 upwardly. As first supporting member 112 and second supporting member 114 are lifted upwardly, holding plate 110 will be lifted upwardly bringing potting soil 310 and plant 312 out of pot 116.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A plant widget, comprising:
a holding plate having an upper and lower surface,
a first supporting member outwardly attached to the upper surface of the holding plate; and the holding plate further comprises at least one aperture.

2. The plant widget of claim 1 further comprising a second supporting member attached to the first supporting member, wherein the first supporting member is received in the bottom end of the second supporting member.

3. The plant widget of claim 1, wherein the holding plate further comprises a variety of sizes and shapes.

4. The plant widget of claim 1, wherein the first supporting member is outwardly attached to a location that is at the center of the upper surface of the holding plate.

5. The plant widget of claim 1, wherein the first supporting member is outwardly attached to a location that is off center off the upper surface of the holding plate.
